(19) United States
(12) Patent Application Publication
(10) Pub. No.: US 2022/0272909 A1
(43) Pub. Date: Sep. 1, 2022

(54) COOLING AND/OR HEATING SYSTEM FOR COOLING AND/OR HEATING PLANT ROOTS, DEVICE FOR GROWING PLANTS, AND METHOD FOR COOLING AND/OR HEATING PLANT ROOTS

(71) Applicant: VIRIDI HOLDING B.V., Hengelo (NL)

(72) Inventor: Johannes Nicolaas VISSER, Nijkerk (NL)

(73) Assignee: VIRIDI HOLDING B.V., Hengelo (NL)

(21) Appl. No.: 17/632,987

(22) PCT Filed: Aug. 7, 2020
(86) PCT No.: PCT/NL2020/050502

§ 371 Date: Feb. 4, 2022

(30) Foreign Application Priority Data
Aug. 8, 2019 (NL) 2023619

(51) Int. Cl. A01G 9/24

(52) U.S. Cl. CPC A01G 9/245

(57) ABSTRACT

A cooling and/or heating system for cooling and/or heating plant roots includes at least one heat transfer element to be disposed in a growth base close to plant roots and a 3D textile through which a fluid can flow and which comprises at least one fluid inlet for admitting the fluid and at least one fluid outlet for discharging the fluid. A device with such a cooling and/or heating system and a growth base for plants, and a method for cooling and/or heating plant roots, where fluid of a determined temperature flows through the at least one heat transfer element for the purpose of cooling and/or heating plant roots.

The invention relates to a cooling and/or heating system for cooling and/or heating plant roots.

It has been found by applicant that it can be efficient from at least an energy viewpoint for the plant roots to be cooled and/or heated instead of or in addition to cooling and/or heating a space and/or ambient air in which the plants are located.

More particularly, the cooling and/or heating of plant roots can alternatively or additionally be understood to mean the cooling and/or heating of a growth base in which the plants are planted, such as for instance soil or a substrate, and the cooling and/or heating of the plant roots thereby. In particular, at least a part of the growth base where the plant roots are situated or at least can be situated during the growth process of the plants can be cooled and/or heated with the cooling and/or heating system according to the invention.

According to the invention, the cooling and/or heating system of the type stated in the preamble comprises at least one heat transfer element to be disposed in a growth base close to plant roots and comprising a 3D textile through which a fluid can flow and which comprises at least one fluid inlet for admitting the fluid and at least one fluid outlet for discharging the fluid.

It has been found by applicant that such a 3D textile can provide a good and/or efficient heat transfer to the growth base in which the 3D textile is disposed and can thereby cool and/or heat the plant roots well and/or efficiently.

The fluid can be any suitable fluid. The use of a liquid, such as water, can be particularly advantageous because, in the case of a liquid, a more efficient heat transport is possible.

The heat transfer element can particularly be configured to be disposed in or under said growth base, for instance to be buried in or to be covered by the growth base. Alternatively, the heat transfer element can be received in or be arranged under said growth base, for instance by burying and/or by arranging the growth base over the heat transfer element.

The growth base can for instance comprise soil or earth, or another suitable medium for plant growth.

In an embodiment of the cooling and/or heating system the system is designed and/or configured to substantially uniformly cool and/or heat the growth base at least close to the plant roots.

The system can particularly be designed and/or configured to uniformly cool and/or heat at least said part of the growth base where the plant roots are situated or at least can be situated during the growth process of the plants.

An advantage of such an even or uniform cooling and/or heating of the growth base is that the plant roots can be cooled and/or heated at substantially the same or a uniform temperature.

Substantially uniformly can for instance be understood to mean that a temperature of the growth base is the same substantially everywhere, at least close to the plant roots or at least in said part of the growth base. The temperature can here for instance vary by a maximum of ±10°, preferably a maximum of ±5°, in said part of the growth base.

In another embodiment of the cooling and/or heating system the system comprises at least one main supply conduit for supplying the fluid and a plurality of sub-supply conduits which are connected on one side to the at least one main supply conduit and are connected on the other side to a stated fluid inlet of one or more heat transfer elements.

An advantage of such a system is that distributed supply of the fluid to one or more heat transfer elements is possible via the at least one main supply conduit and the plurality of sub-supply conduits, which ensures or contributes to the uniform cooling and/or heating of the growth base and/or the plant roots via the at least one heat transfer element.

In this embodiment the sub-supply conduits branch off from the at least one main supply conduit.

In this embodiment there can for instance be an elongate heat transfer element with a plurality of fluid inlets disposed distributed over the length of the heat transfer element, so that the fluid is supplied to the heat transfer element distributed over the length thereof and the heat transfer element can heat the growth base and/or the plant roots substantially uniformly. Alternatively or additionally, in this embodiment there can be a plurality of heat transfer elements, each with one or more fluid inlets, so that together the heat transfer elements can ensure or contribute to a substantially uniform cooling and/or heating.

In this embodiment the main supply conduit can be arranged at any suitable position. It can for instance be arranged in the growth base, so that the main supply conduit contributes to the cooling and/or heating of the growth base and/or plant roots. The main supply conduit could alternatively be arranged under or above the growth base, for instance if a contribution thereby to the cooling and/or heating is undesirable and must therefore be prevented or limited.

In practical manner the system comprises at least one main discharge conduit for discharging the fluid and a plurality of sub-discharge conduits which are connected on one side to the at least one main discharge conduit and are connected on the other side to a stated fluid outlet of one or more heat transfer elements.

The at least one heat transfer element can preferably be disposed under the plant roots, more particularly almost directly on the plant roots. At such a position the plant roots can be cooled and/or heated effectively by the heat transfer element.

In yet another embodiment of the system according to the invention the system comprises heating means and/or cooling means for heating and/or cooling the fluid.

The heating means and/or cooling means can be embodied in any suitable manner. The heating means and/or cooling means can for instance comprise an electric heating and/or cooling element.

Residual heat can for instance alternatively or additionally be used to heat the fluid, or residual fluid of a suitable temperature can be reused in the system according to the invention.

In yet another embodiment of the system according to the invention the system comprises temperature setting means for setting a temperature of the heating means and/or cooling means and thereby a temperature of the fluid.

The temperature setting means can for instance comprise a temperature sensor for measuring the temperature of the fluid, wherein the heating means and/or cooling means are controlled on the basis of the measured temperature and the set temperature.

In yet another embodiment of the system according to the invention the system comprises a container for containing fluid, which container comprises the heating means and/or cooling means, and wherein the container is connected to the at least one fluid inlet and at least one fluid outlet of the at least one heat transfer element.

An advantage of such a container is that a supply of fluid can be heated and/or cooled and can thus be kept at a desired temperature.

It can alternatively be the case that the fluid is heated and/or cooled during transport to the at least one heat transfer element.

In practical manner the system can further comprise control means, such as for instance a processor, for the purpose of controlling the system.

In another embodiment of the system according to the invention the 3D textile comprises two main surfaces extending substantially parallel to each other at a mutual distance, wherein the main surfaces each comprise at least one textile layer and wherein the main surfaces are connected to each other by means of a number of pile threads.

The two main surfaces disposed at a distance from each other define a space therebetween, through which space the fluid can flow. The number of pile threads is also situated in this space. When the fluid flows through the space, the flow is deflected or even becomes turbulent due to the presence of the pile threads. It has been found by applicant that heat transfer between the growth base and the heat transfer element can be enhanced thereby.

The 3D textile can be manufactured by weaving or knitting the textile layers of the two main surfaces simultaneously. The number of pile threads is preferably woven or knitted in directly during the weaving process, whereby an integrally woven or knitted 3D textile results. The pile threads can thus be the same threads as those with which one or both textile layers are woven.

The textile layers and pile threads can be manufactured from any suitable material, for instance from a plastic or metal. The textile layers and pile threads can here be manufactured from the same material or from different materials. At least some of the pile threads can particularly be manufactured from a heat-conducting material, so that the heat transfer to the fluid can be increased further still. At least the pile threads can for instance be manufactured from copper, aluminium or stainless steel.

In practical manner at least one of the two main surfaces can be fluid-impermeable. This can for instance be achieved by providing the two textile layers with a fluid-impermeable coating or sealing layer.

The main surfaces can be connected to each other in fluid-impermeable manner along a peripheral edge. The fluid is hereby unable to leave the space via the peripheral edge.

The 3D textile can alternatively or additionally be enclosed at least partially by a fluid-impermeable frame. The frame can thus for instance extend round the peripheral edge. The frame can alternatively or additionally extend over at least one of the two main surfaces.

The invention also relates to a device for growing plants, such as for instance a greenhouse, comprising:
a cooling and/or heating system as described above on the basis of one or more of the described embodiments and/or with one or more of the above described features, alone or in any random combination;
a growth base, such as for instance soil or a substrate, for growing plants therein,

wherein the at least one heat transfer element is disposed in the growth base at a location close to the plants to be grown therein.

The advantages of such a device are elucidated above on the basis of the cooling and/or heating system according to the invention.

In practical manner the at least one heat transfer element can be arranged fully covered in the growth base, wherein the plants to be grown in the growth base are situated above the at least one heat transfer element.

In this way the heat transfer element can cool and/or heat the part of the growth base where the plant roots are situated in simple manner.

The invention also relates to a method for cooling and/or heating plant roots, wherein use is made of a cooling and/or heating system as described above on the basis of one or more of the described embodiments and/or with one or more of the above described features, alone or in any random combination, or a device as described above on the basis of one or more of the described embodiments and/or with one or more of the above described features, alone or in any random combination, and comprising the step of having fluid of a determined temperature flow through the at least one heat transfer element for the purpose of cooling and/or heating plant roots situated close to the at least one heat transfer element.

The invention is further elucidated below with reference to the accompanying schematic figures, in which:

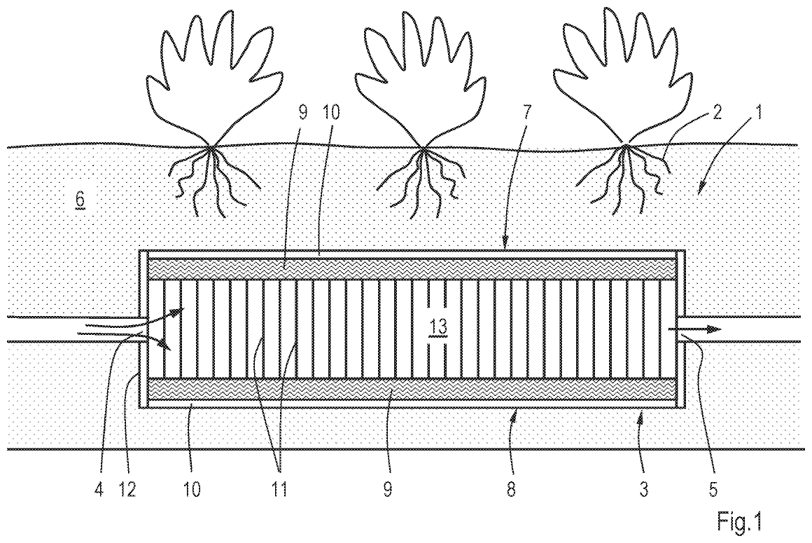

FIG. 1 is a schematic vertical cross-section through a growth base with a cooling and/or heating system according to a first embodiment of the invention;

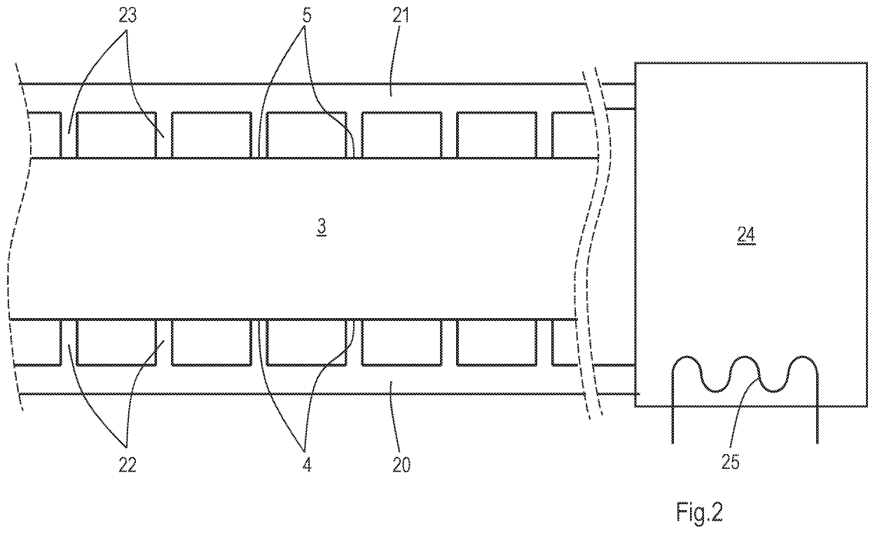

FIG. 2 is a schematic top view of the system of FIG. 1, wherein for the sake of clarity only the system is shown, and

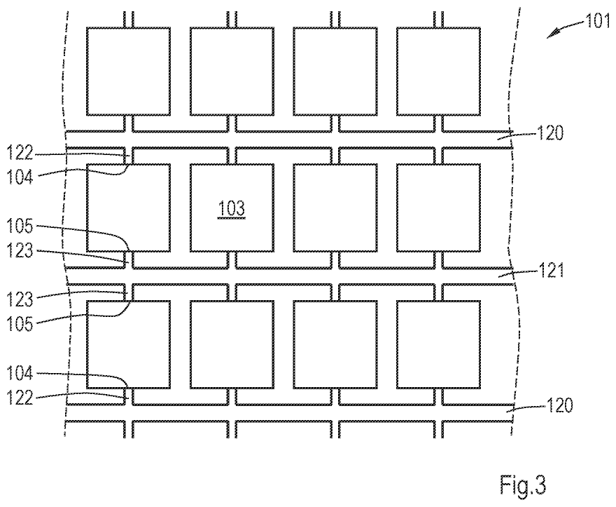

FIG. 3 is a schematic top view of a cooling and/or heating system according to a second embodiment of the invention, wherein for the sake of clarity only the system is shown.

The same elements are always designated in the figures with the same reference numerals, increased by a hundred (100) for the second embodiment.

FIGS. 1 and 2 show a cooling and/or heating system 1 for cooling and/or heating plant roots 2. System 1 comprises a heat transfer element 3 in the form of a 3D textile through which a fluid can flow and which has a number of fluid inlets 4 for admitting the fluid and a number of fluid outlets 5 for discharging the fluid. As shown in FIG. 1, the heat transfer element 3 is disposed in a growth base 6, such as for instance soil or a substrate, at a location just below plant roots 2. By having a fluid with a relatively low or relatively high temperature flow through heat transfer element 3 the growth base 6 can be respectively cooled or heated at least in an area of plant roots 2, so that plant roots 2 are respectively cooled or heated.

As shown in FIG. 1, heat transfer element 3 in the form of the 3D textile comprises in this case two fluid-impermeable main surfaces 7, 8, these lying at a distance from each other. Main surfaces 7, 8 each comprise a textile layer 9 and a sealing layer 10. It is also possible for a plurality of sealing layers 10 to be provided, and/or for a sealing layer to continue at least to a position between the fibres of textile layer 9. In this case textile layer 9 is not fluid-impermeable per se, and sealing layer 10 is. Pile threads 11 extend between the textile layers 9 of each main surface 7, 8. In this embodiment the main surfaces 7, 8 are connected to each other in fluid-impermeable manner along the edges, in this case by a side edge 12. The 3D textile defines between main surfaces 7, 8 and between pile threads 11 a throughflow space 13 through which the fluid can flow. When the fluid flows through space 13, the flow is deflected or even becomes turbulent due to the presence of pile threads 11. A good heat transfer from the fluid to growth base 6 can hereby take place, and growth base 6 can be cooled and/or heated efficiently and/or well.

According to an aspect of the invention, system 1 is designed and/or configured to substantially uniformly cool and/or heat growth base 6 at least close to plant roots 2. In this first embodiment of the system 1 according to the invention this is achieved at least partly in that system 1 comprises a main supply conduit 20 for supplying the fluid, to which main supply conduit 20 a plurality of sub-supply conduits 22 connect, which sub-supply conduits 22 then connect to a respective fluid inlet 4 of a plurality of fluid inlets 4. In other words, the sub-supply conduits 22 extend here between main supply conduit 20 and fluid inlets 4. Fluid outlets 5 extend on a side of heat transfer element 3 opposite to the fluid inlets 4, which outlets are connected via respective sub-discharge conduits 23 to a main discharge conduit 21. In this embodiment fluid is supplied via main supply conduit 20 and then fed in distributed manner into heat transfer element 3 via the sub-supply conduits 22 and fluid inlets 4. In heat transfer element 3 the fluid flows through the space 13 shown in FIG. 1 to the other side of heat transfer element 3, and leaves heat transfer element 3 via fluid outlets 5, sub-discharge conduits 23 and main discharge conduit 21. The distributed supply of the fluid to heat transfer element 3 enables a substantially uniform cooling and/or heating of growth base 6 to take place.

It is noted that FIG. 2 shows only one, substantially elongate, heat transfer element 3. It will however be apparent to the skilled person that a plurality of optionally elongate heat transfer elements 3 can be provided. A plurality of elongate heat transfer elements 3 can for instance be disposed parallel and adjacently of each other so as to collectively cool and/or heat a relatively large surface area of growth base 6. The heat transfer elements can have their own main supply conduit 20 and/or main discharge conduit 21, or they can share a main supply conduit 20 and/or main discharge conduit 21.

FIG. 2 further shows that in this embodiment the system 1 has a container 24 in which fluid can be stored. It can thus be stated in respect of container 24 that it functions as a buffer for hot and/or cold fluid. Arranged in the container is a cooling and/or heating element 25, using which the fluid can be cooled and/or heated to a desired, and preferably set, temperature. The main supply conduit 20 and main discharge conduit 21 are connected to container 24 so that fluid from container 24 can be supplied via main supply conduit 20 to heat transfer element 3 and can be transported via main discharge conduit 21 back to container 24.

It is noted that fluid with a relatively high temperature can be situated at the top of container 24 and fluid with a relatively low temperature at the bottom of container 24. It can hereby be advantageous for the one conduit of conduit 20, 21 to connect to an upper zone of container 24 and for the other conduit of conduits 20, 21 to connect to a lower zone of container 24, and for a suitable conduit of conduits 20, 21 to be used as main supply conduit and the other as main discharge conduit, depending on whether roots 2 must be cooled or heated.

Means for mixing the fluid can alternatively or additionally be provided in container 24 so that the fluid in container 24 has a substantially uniform temperature. In such a case it is possible for conduits 20, 21 to connect to container 24 at the same height.

FIG. 3 shows schematically a system 101 according to a second embodiment of the invention. Only the differences from system 1 according to the first embodiment of FIGS. 1 and 2 will be described here. For a further description reference is made to the above description relating to FIGS. 1 and 2.

System 101 comprises a plurality of heat transfer elements 103, in this case substantially square as seen in top view. Although shown square here, the heat transfer elements can also have any other suitable shape. The main supply conduits 120 and main discharge conduits 121 connect via sub-supply conduits 122 and sub-discharge conduits 123 to heat transfer elements 103 disposed on either side thereof. In other words, two adjacent rows of heat transfer elements 103 in each case share a conduit 120, 121 disposed therebetween.

FIG. 3 shows no container for containing fluid. If desired, such a container can be provided. Alternatively, main supply conduits 120 and main discharge conduits 121 can be connected directly to the water mains, and the fluid can be cooled and/or heated during transport to the heat transfer elements 103.

Although the invention is elucidated above on the basis of a number of specific examples and embodiments, the invention is not limited thereto. The invention instead also covers the subject matter defined by the following claims.

1. A cooling and/or heating system for cooling and/or heating plant roots, comprising:
at least one heat transfer element to be disposed in a growth base close to plant roots and
a 3D textile through which a fluid can flow and which comprises at least one fluid inlet for admitting the fluid and at least one fluid outlet for discharging the fluid.

2. The cooling and/or heating system according to claim 1, wherein the system is configured to substantially uniformly cool and/or heat the growth base at least close to the plant roots.

3. The cooling and/or heating system according to claim 1, comprising at least one main supply conduit for supplying the fluid and a plurality of sub-supply conduits which are connected on one side to the at least one main supply conduit and are connected on the other side to a stated fluid inlet of one or more heat transfer elements.

4. The cooling and/or heating system according to claim 1, comprising at least one main discharge conduit for discharging the fluid and a plurality of sub-discharge conduits which are connected on one side to the at least one main discharge conduit and are connected on the other side to a stated fluid outlet of one or more heat transfer elements.

5. The cooling and/or heating system according to claim 1, wherein the at least one heat transfer element is configured to be disposed under the plant roots.

6. The cooling and/or heating system according to claim 1, comprising heating means and/or cooling means for heating and/or cooling the fluid.

7. The cooling and/or heating system according to claim 6, comprising temperature setting means for setting a temperature of the heating means and/or cooling means and thereby a temperature of the fluid.

8. The cooling and/or heating system according to claim 6, comprising a container for containing fluid, the container comprising the heating means and/or cooling means, and wherein the container is connected to the at least one fluid inlet and at least one fluid outlet of the at least one heat transfer element.

9. The cooling and/or heating system according to claim 1, wherein the 3D textile comprises two main surfaces extending substantially parallel to each other at a mutual distance, wherein the main surfaces each comprise at least one textile layer and wherein the main surfaces are connected to each other by means of a number of pile threads.

10. The cooling and/or heating system according to claim 9, wherein at least one of the two main surfaces is fluid-impermeable.

11. The cooling and/or heating system according to claim 9, wherein the main surfaces are connected to each other in fluid-impermeable manner along a peripheral edge.

12. The cooling and/or heating system according to claim 1, wherein the 3D textile is enclosed at least partially by a fluid-impermeable frame.

13. A device for growing plants comprising:
a cooling and/or heating system according to claim 1;
a growth base for growing plants therein,
wherein the at least one heat transfer element is disposed in the growth base at a location close to the plants to be grown therein.

14. The device according to claim 13, wherein the at least one heat transfer element is arranged fully covered in the growth base and the plants to be grown in the growth base are situated above the at least one heat transfer element.

15. A method for cooling and/or heating plant roots, comprising:
providing a cooling and/or heating system for cooling and/or heating plant roots, comprising:
at least one heat transfer element to be disposed in a growth base close to plant roots, and
a 3D textile through which a fluid can flow and which comprises at least one fluid inlet for admitting the fluid and at least one fluid outlet for discharging the fluid;
flowing fluid of a determined temperature through the at least one heat transfer element to cool and/or heat plant roots situated close to the at least one heat transfer element.

16. The method of claim 15, further comprising a growth base for growing plants therein, wherein the at least one heat transfer element is disposed in the growth base at a location close to the plants to be grown therein.
